(19) United States
(12) Patent Application Publication
(10) Pub. No.: US 2006/0283621 A1
(43) Pub. Date: Dec. 21, 2006

(54) Electric wire having a core of aluminum or aluminum alloy

(76) Inventors: Francis Debladis, Arras (FR); Christophe Brismalein, Lievin (FR)

Correspondence Address: SOFER & HAROUN, L.L.P., Suite 910, 317 Madison Avenue, New York, NY, 10017, US

(21) Appl. No.: 11/350,395

(22) Filed: Feb. 8, 2006

(30) Foreign Application Priority Data
Feb. 10, 2005 (FR) 05 50398

(51) Int. Cl. H01B 5/08

(52) U.S. Cl. 174/128.1

(57) ABSTRACT

The invention relates to an electric wire comprising an aluminum or aluminum alloy core provided with a metallic coating. According to the invention, said coating layer is an alloy of tin and zinc, said coating layer being deposited on the core by electrodeposition.

### RELATED APPLICATION

This application is related to and claims the benefit of priority from French Patent Application 05 50398, filed on Feb. 10, 2005, the entirety of which is incorporated herein by reference.

### FIELD OF THE INVENTION

The invention relates to an electric wire having a core of aluminum or aluminum alloy.

### BACKGROUND OF THE INVENTION

When an aluminum or aluminum alloy wire is crimped in a crimping sleeve, and given the difference in the thermal expansion coefficients of aluminum and the metal constituting the crimping sleeve, which is often a copper alloy, alumina is formed around the wire by oxidation in air. Unfortunately, alumina is electrically resistive and consequently leads to an increase in electrical contact resistance, which can lead to contact being broken, when conveying light currents, or else to overheating, when conveying heavy currents.

### OBJECT OF THE INVENTION

The object of the invention is to avoid this formation of a layer of aluminum around at the electric wire by coating the wire in a material that does not present insulating properties that are harmful to good electrical operation of the conductor.

Patent document GB 790 015 discloses that it is known to make an electric wire with an aluminum or aluminum alloy core provided with a coating layer of tin.

However, that solution poses the following problem.

Tin is less electronegative than aluminum, and protects aluminum poorly in the event of galvanic corrosion.

Finally, under certain conditions, coatings of pure tin are liable to develop filaments.

### BRIEF SUMMARY OF THE INVENTION

To solve this problem, the invention provides an electric wire comprising an aluminum or aluminum alloy core provided with a metallic coating layer, wherein said coating layer is an alloy of tin and the zinc, said coating layer being deposited on the core by electrodeposition.

Depositing this alloy by electrodeposition provides better control concerning the quality and the thickness of the layer them does depositing it by hot dipping. Furthermore, the process is reproducible.

In a preferred embodiment, said tin and zinc alloy is a co-deposit on said core, i.e. tin and zinc become alloyed while they are being deposited on the aluminum or aluminum alloy core.

Preferably, said alloy comprises a content by weight of tin lying in the range 60% to 80%.

Preferably, said alloy comprises a content by weight of zinc lying in the range 20% to 40%.

Advantageously, said alloy comprises a content by weight of tin that it is substantially equal to 70% and a content by weight of zinc that is substantially equal to 30%.

The thicknesses said coating layer may lie in the range 0.5 micrometers (μm) to 10 μm.

The invention also relates to a multistrand electric conductor made by assembling together a plurality of wires as specified above.

Finally, the invention relates to a single strand electric conductor constituted by a wire as specified above.

### BRIEF DESCRIPTION OF THE DRAWING

The invention is described below in greater detail with the help of the figures that show merely a preferred embodiment of the invention.

FIG. 1 is the cross-section view of a wire in accordance with the invention.

FIG. 2 is a perspective view of an electric conductor made up of wires in accordance with the invention.

### MORE DETAILED DESCRIPTION

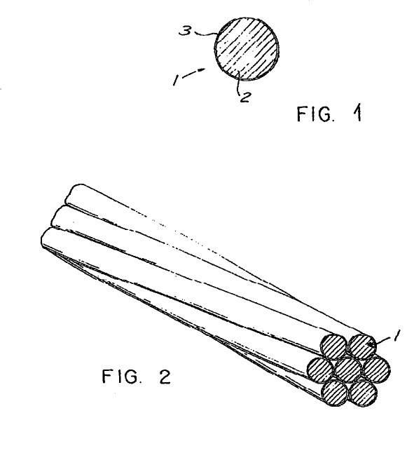

As can be seen in FIG. 1, an electric wire 1 comprises a core 2 of aluminum or aluminum alloy provided with a coating layer 3 of tin and zinc alloy, preferably a co-deposit of tin and of zinc.

According to the invention, the alloy includes a content by weight of tin lying in the range 60% to 80%, and a content by weight of zinc lying in the range 20% to 40%.

In a particular embodiment, the alloy comprises a content by weight of tin that is substantially equal to 70% and a content by weight of zinc that is substantially equal to 30%.

The thickness of the coating layer 3 lies in the range 0.5 μm to 10 μm.

An electric wire in accordance with the invention is manufactured by wire-drawing. The coating layer 3 is deposited by electrodeposition on a core in an intermediate state, and then the core and the coating layer are drawn down together to the final diameter.

The invention is preferably applied to the wires of aluminum or aluminum alloy having a diameter lying in the range 0.08 millimeters (mm) to 12 mm, in the finished state after drawing.

Wires one as obtained in this way can be assembled and twisted together to form a multistrand electric cable as shown in FIG. 2.

The invention also applies to wires of large diameter suitable for making a single strand conductor.

What is claimed is:

1. An electric wire comprising: an aluminum or aluminum alloy core provided with a metallic coating layer, wherein said coating layer is an alloy of tin and of zinc, said coating layer being deposited on the core by electrodeposition.

2. An electric wire according to claim 1, wherein said alloy of tin and zinc is a co-deposit on said core.

3. An electric wire according to claim 1, wherein said alloy has a content by weight of tin lying in the range 60% to 80%.

4. An electric wire according to claim 1, wherein said alloy has a content by weight of zinc lying in the range 20% to 40%.

5. An electric wire according to claim 1, wherein said alloy has a content by weight of tin that is substantially equal to 70%, and a content by weight of zinc that is substantially equal to 30%.

6. An electric wire according to claim 1, wherein the thickness of said coating layer lies in the range 0.5 μm to 10 μm.

7. A multistrand electric conductor made by assembling together a plurality of wires according to claim 1.

8. A single strand electric conductor constituted by a wire according to claim 1.
